(19) United States
(12) Patent Application Publication
(10) Pub. No.: US 2019/0287357 A1
(43) Pub. Date: Sep. 19, 2019

(54) EMBEDDED ELECTRONICS FOR FASHION ACCESSORIES AND RELATED SYSTEMS AND ARTICLES OF MANUFACTURE

(71) Applicant: Muzik Inc., West Hollywood, CA (US)

(72) Inventor: Jason Hardi, Beverly Hills, CA (US)

(21) Appl. No.: 16/353,445

(22) Filed: Mar. 14, 2019

Related U.S. Application Data
(60) Provisional application No. 62/642,914, filed on Mar. 14, 2018.

(51) Int. Cl. G08B 5/22; A45C 13/42; A43C 19/00

(52) U.S. Cl. CPC G08B 5/228; A43C 19/00; A45C 13/42

(57) ABSTRACT

A fashion accessory can include an electronic circuit embedded within the fashion accessory, where the electronic circuit can be configured to receive a wireless signal from an electronic device that is operatively coupled to the electronic circuit, the wireless signal indicating an incoming message to the electronic device. An indicator on an exterior of the fashion accessory can be electrically responsive to the electronic circuit receiving the wireless signal.

### CLAIM FOR PRIORITY

This application claims priority to U.S. Provisional Application Ser. No. 62/642,914 entitled Embedded Electronics for Fashion Accessories, filed in USPTO Mar. 14, 2018 the entire content of which is hereby incorporated herein by reference.

### FIELD OF THE INVENTION

The present invention relates to the field of electronics in general, and more particularly, to electronics for communications.

### BACKGROUND

Fashion accessories are popular with consumers. Those consumers also happen to have electronic devices, such as mobile phones that are sometimes carried inside a fashion accessory, such as a handbag. Further, counterfeiting of fashion accessories (particularly those associated with luxury brands) is an on-going problem.

### SUMMARY

Embodiments according to the invention can provide embedded electronics for fashion accessories and related systems and articles of manufacture. Pursuant to these embodiments, a fashion accessory can include an electronic circuit embedded within the fashion accessory, where the electronic circuit can be configured to receive a wireless signal from an electronic device that is operatively coupled to the electronic circuit, the wireless signal indicating an incoming message to the electronic device. An indicator on an exterior of the fashion accessory can be electrically responsive to the electronic circuit receiving the wireless signal.

In some embodiments, a fashion accessory can include an electronic circuit embedded inside an accoutrement attached to an exterior of the fashion accessory, where the electronic circuit can be configured to receive a wireless signal from an electronic device operatively coupled to the electronic circuit, the wireless signal indicating an incoming message to the electronic circuit. An indicator can be on an exterior of the accoutrement and electrically responsive to the electronic circuit receiving the wireless signal.

### BRIEF DESCRIPTION OF THE FIGURES

FIG. 1 is a block diagram illustrating embedded electronics in fashion accessories to provide communications via mobile devices in some embodiments according to the invention.

FIG. 2 is a schematic illustration of a shoe fashion accessory that includes the wireless receiver portion in the solo or in the heel as well as the other components including the embedded electronics shown in FIG. 1 in some embodiments according to the invention.

FIG. 3 is a schematic illustration of a handbag as a fashion accessory which is configured to carry a mobile device as well as the receiver circuit of the embedded electronics in some embodiments according to the invention.

FIG. 4 is a block diagram of a fashion accessory including a fob configured to provide authentication of the fashion accessory as part of a blockchain system in some embodiments.

### DETAILED DESCRIPTION OF EMBODIMENTS ACCORDING TO THE INVENTION

As described herein, in some embodiments according to the invention, fashion accessories such as shoes and handbags can be configured to provide charging of electronics which are embedded or otherwise contained within the fashion accessories. Embedding the electronics within the fashion accessory and allowing for wireless charging can allow for the convenient recharging and carrying of electronics for interfacing with other mobile communications devices, such as cellular telephones, which can support more convenient calling or reception of calls.

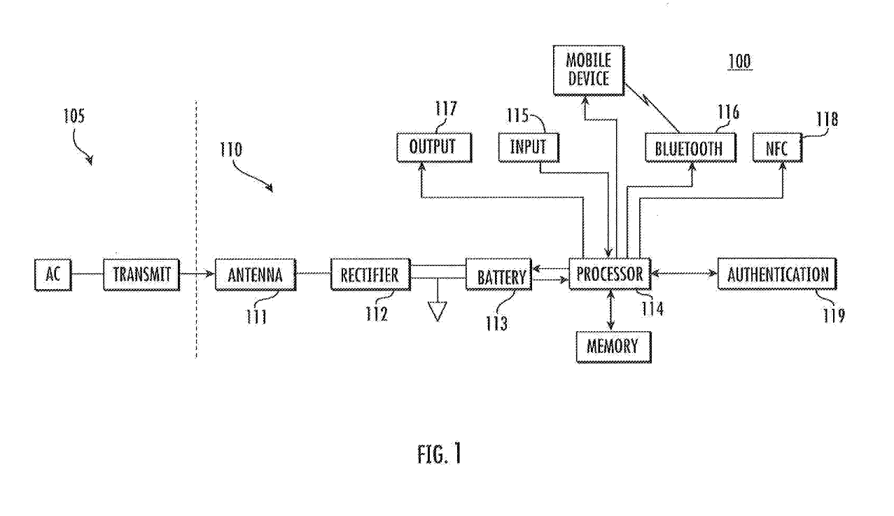

FIG. 1 is a block diagram illustrating embedded electronics in fashion accessories to provide communications via mobile electronics in some embodiments according to the invention. According to FIG. 1, the System 100 includes a wireless power transfer (WPT) transmitter circuit 185 that is outside the fashion accessory and a WPT receiver circuit 110 that is at least partially embedded in the fashion accessory. It will be understood that the term embedded, as used herein, includes arrangements where at least some portion of the receiver circuit 110 is affixed to either an interior surface of or an interior space within the fashion accessory (such as within the interior compartment of a handbag) or enclosed within the sole or heel of a shoe in some embodiments according to the invention.

Referring to FIG. 1, the WPT transmitter circuit 105 receives AC power which is transmitted to the WPT receiver circuit 110 via wireless induction to provide an AC signal to an antenna circuit 111 and a rectifier circuit 112 that generates DC power to a battery 113 in some embodiments according to the invention. It will be further understood that the antenna circuit 111 and the rectifier circuit 112 may be included in an integrated circuit or may be included within the processor circuit shown in FIG. 1. In other words, in some embodiments according to the invention, the rectifier circuit 112 and antenna circuit 111 may be part of the processor that provides overall operations of the embedded electronics shown in FIG. 1.

Still referring to FIG. 1, the DC power is stored within the battery 113 which is made available to a processor circuit 114 that provides overall operation of the embedded electronic system 100 in some embodiments according to the invention. It will be understood that the processor circuit 114 operates using a memory that provides for the storage of programmable code that coordinates the operations of the embedded system 100 by storing instructions executed by the processor circuit 114 as well as data utilized by the system 100.

As further shown in FIG. 1, the processor circuit 114 is coupled to an input circuit 115 which can be used to activate a function of the fashion accessory. In some embodiments according to the invention, the input circuit 115 can be provided by a clasp or other accoutrement of the handbag or may be a button or other surface accoutrement on a shoe. The input circuit 115 can be configured to activate a function within the processor circuit 114 to provide feature of the embedded electronics 100. For example, in some embodiments according to the invention, activating the input circuit 115 may cause the processor circuit 114 to initiate a 911 call using a Bluetooth circuit 116 coupled to a mobile device which is connected to a cellular system. Accordingly, when the user presses the input circuit 114 the processor circuit 114 can activate a predetermined operation (such as a 911 call or another predetermined number) using a connection to the mobile device using the Bluetooth circuit 116 shown in FIG. 1.

As further shown in FIG. 1, the embedded electronics 100 also includes an output circuit 117 coupled with the processor circuit 114. In some embodiment, the output circuit 117 can be a light (or other indicator) used by the processor circuit 114 to generate an indication of a detected event (such as an incoming call or the initiation of a 911 call). For example, in some embodiments according to the invention, the processor circuit 114 may detect an incoming call over the Bluetooth circuit 116 and may activate the output circuit 117 in response to the detected call. When a predetermined caller is detected the processor circuit 114 may activate the output (such as a light) to notify the user that an incoming call has been detected. Accordingly, the user may carry a mobile telephone within a handbag and may be notified of the incoming call when the clasp or a fob attached to the handbag is illuminated in response to detecting the call. Still further, the clasp or a fob can function as the input circuit 115 and as the output circuit 117. In still further embodiments according to the invention, the processor circuit 114 can be coupled to an NFC circuit 118 which can be used to carryout commercial transactions with local merchants such as to make purchases without removing a mobile device from the fashion accessory.

In still further embodiments according to the invention, the processor circuit 114 can be coupled to an authentication circuit 119 which can be used to record an authentication mechanism associated with the fashion accessory such that, in a retail environment, when the fashion accessory is sold to the original purchaser, the authentication circuit 119 can store an authentication code which is registered in an authentication system that is external to the embedded system 100, such as on a cloud network. For example, in some embodiments according to the invention, the authentication information can be recorded in a blockchain which records the purchaser's identity as well as unique information identifying the particular fashion accessory (such as a serial number which is recorded in the blockchain. If the fashion accessory is stolen or is transferred in a sale from the original purchaser to a secondary purchaser, the secondary purchaser can authenticate the fashion accessory before completing a transaction by accessing the blockchain. Further, the originator or the fashion accessory can use the embedded electronics 100 to detect that the fashion accessory is genuine and not a counterfeit item.

Furthermore, in the embedded electronics 100 can be part of a subscription service whereby a subscriber can receive particular types of data from the embedded electronics 100 in a secure and frictionless transaction. For example, in an IoT ecosystem supported by blockchain technology, the subscriber may deploy a system that communicates with certain ones of the electronics 100 for receipt of particular retail transaction associated therewith using the NFC circuit 118. In operation, the subscription system would, for example, receive the operating data without the need for subscriber intervention. Still further, the operator, owner of the fashion accessory, or other party can receive revenue from the subscriber.

In still further embodiments according to the invention, the receiver portion 110 is located in the interior space within the fashion accessory and can be electrically coupled to a mobile device (also in the interior space) for recharging without removing the mobile device from the fashion accessory. For example, the mobile device can be a mobile telephone that can be charged wirelessly when coupled to the receiver circuit 110. It will be understood that the receiver portion 110 may provide multiple ones of the functions described herein simultaneously or at different times.

FIG. 2 is a schematic illustration of a shoe 200 as a fashion accessory that includes the wireless receiver portion 110 shown in the sole or in the heel as well as the other components including the embedded electronics shown in FIG. 1. Accordingly, in some embodiments according to the invention, the user may be notified of an incoming call when an accoutrement 255 of the fashion accessory is illuminated in response to an incoming call. Still further, the accoutrement 255 can also be used to receive input that activates a predetermined action such as a 911 call and provides the output 115 circuit.

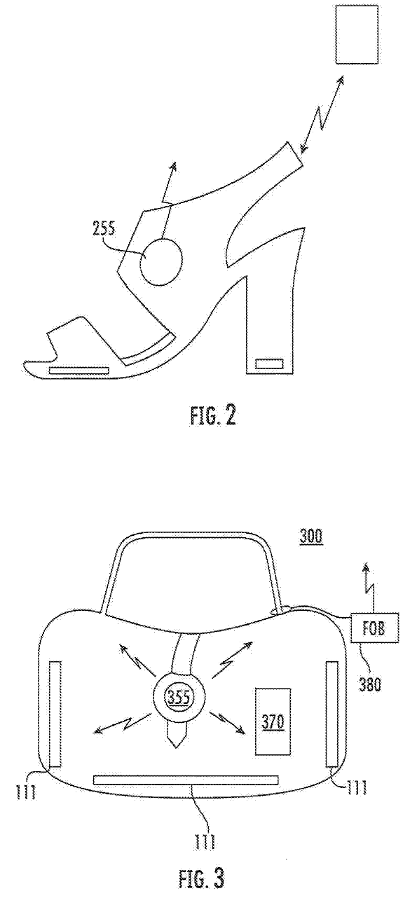

FIG. 3 is a schematic illustration of a handbag 300 as a fashion accessory which is configured to carry a mobile telephone 370 as well as the receiver circuit 110 of the embedded electronics 100. Accordingly, when an incoming call is detected the user may be notified of the incoming call by illuminating an accoutrement as the output circuit 117 of the fashion accessory (such as the clasp or a fob that is associated with the fashion accessory) so that the user may respond to the call even though the phone is silenced and stored within the handbag.

In still further embodiments according to the invention as shown in FIG. 3 the antenna circuit 111 of the receiver portion 110 can be oriented in the lower portion of the handbag 300 or in the side portions of the handbag 300 depending on which orientation the transmitter circuit 105 is configured in. In still further embodiments according to the invention, the accoutrement 355 on the outside of the fashion accessory may be used to provide the input circuit 115 to the embedded electronics 100 to initiate the call such as pressing the fob or the clasp on a handbag as well as the output circuit 117. Still further in some embodiments according to the invention, the embedded electronics 100 may be entirely contained within the fob 380 shown in FIG. 3 or in the clasp 355 shown in FIG. 3. In still further embodiments according to the invention, the authentication circuit 119 can be used to store authentication information in the fob which is later interrogated to determine whether the handbag is an authentic handbag according to the external system described above in reference to FIG. 1.

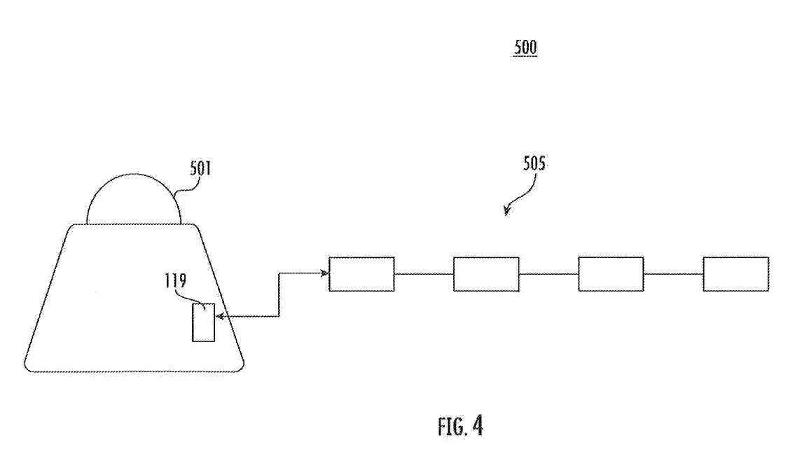

FIG. 4 is a block diagram of a fashion accessory 501 including a fob 119 configured to provide authentication of the fashion accessory 501 as part of a blockchain system 505 in some embodiments according to the invention. As shown in FIG. 4, the fob 119 is programmed to include information that uniquely identifies the accessory as being authentic. The information can be part of what may be referred to as a blockchain system 505 that allows a distributed ledger to be maintained so that the accessory can be programmed with the authentication information by an authorized retail seller. Subsequent transactions by third parties can be authenticated using the blockchain system 505 that as that described in Blockchain for Dummies, which is available on the Internet at ibm.com/downloads/cas/36KBMBOG, the entire disclosure of which is incorporated herein by reference. For example, buyers and sellers can transact using the blockchain system so that subsequent purchasers can have confidence that the accessory 500 is authentic and not a counterfeit item. The authentication information may also be used by an authorized agent of retailer to authenticate the accessory for warranty claims.

It will be understood that the term blockchain can refer to a decentralized, distributed and public digital ledger that is used to record transactions across many computers so that any involved record cannot be altered retroactively, without the alteration of all subsequent blocks. This allows the participants to verify and audit transactions independently and relatively inexpensively.

A list of records, sometimes referred to as blocks, can be linked using cryptography. Each block can contain a cryptographic hash of the previous block, a timestamp, and transaction data. Accordingly, a blockchain can be resistant to the modification of the data it is associated with. It is “an open, distributed ledger that can record transactions between two parties efficiently and in a verifiable and permanent way”. For use as a distributed ledger, a blockchain is typically managed by a peer-to-peer network collectively adhering to a protocol for inter-node communication and validating new blocks.

Once recorded, the data in any given block cannot be altered retroactively without alteration of all subsequent blocks, which requires consensus of the network majority. Although blockchain records are not unalterable, blockchains may be considered secure by design and exemplify a distributed computing system with high Byzantine fault tolerance. Decentralized consensus has therefore been claimed with a blockchain.

A blockchain database can be managed autonomously using a peer-to-peer network and a distributed timestamping server. They are authenticated by mass collaboration powered by collective self-interests. The use of a blockchain type system can maintain title rights because, when properly set up to detail the exchange agreement, it provides a record that compels offer and acceptance. In other words, the authenticity of a particular object can be validated by protecting the digital data associated with it.

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including”, “have” and/or “having” when used herein, specify the presence of stated features, integers, steps, operations, elements, and/or components, but do not preclude the presence or addition of one or more other features, integers, steps, operations, elements, components, and/or groups thereof. Elements described as being “to” perform functions, acts and/or operations may be configured to or other structured to do so.

Unless otherwise defined, all terms (including technical and scientific terms) used herein have the same meaning as commonly understood by one of ordinary skill in the art to which various embodiments described herein belong. It will be further understood that terms used herein should be interpreted as having a meaning that is consistent with their meaning in the context of this specification and the relevant art and will not be interpreted in an idealized or overly formal sense unless expressly so defined herein.

As will be appreciated by one of skill in the art, various embodiments described herein may be embodied as a method, data processing system, and/or computer program product. Furthermore, embodiments may take the form of a computer program product on a tangible computer readable storage medium having computer program code embodied in the medium that can be executed by a computer.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wired, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages, such as a programming language for a FPGA, Verilog, System Verilog, Hardware Description language (HDL), and VHDL. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computer environment or offered as a service such as a Software as a Service (SaaS).

Some embodiments are described herein with reference to flowchart illustrations and/or block diagrams of methods, systems and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall support claims to any such combination or subcombination.

While the foregoing is directed to aspects of the present disclosure, other and further embodiments of the disclosure may be devised without departing from the basic scope thereof, and the scope thereof is determined by the claims that follow.

What is claimed:

1. A fashion accessory comprising:
an electronic circuit embedded within the fashion accessory, the electronic circuit configured to receive a wireless signal from an electronic device operatively coupled to the electronic circuit, the wireless signal indicating an incoming message to the electronic device; and
an indicator on an exterior of the fashion accessory electrically responsive to the electronic circuit receiving the wireless signal.

2. The fashion accessory of claim 1 wherein the indicator comprises an illuminating fob including indicia of a brand associated with the fashion accessory.

3. The fashion accessory of claim 1 wherein the indicator comprises authentication information to verify authenticity of the fashion accessory.

4. The fashion accessory of claim 1 further comprising:
a wireless power transfer receiver circuit inside the fashion accessory and configured to generate DC power; and
a battery electrically coupled to the DC power and to the electronic circuit.

5. The fashion accessory of claim 4 further comprising:
a transceiver circuit inside the fashion accessory, the transceiver circuit configured to receive the wireless signal responsive to a phone call to the electronic device.

6. The fashion accessory of claim 1 wherein the indicator comprises a clasp on an exterior the fashion accessory.

7. The fashion accessory of claim 6 wherein the indicator further comprises an indicia of a brand associated with the fashion accessory.

8. The fashion accessory of claim 3 wherein the authentication information comprises a reference a block in a distributed ledger associated with the fashion accessory

9. The fashion accessory of claim 2 comprising a fashion handbag.

10. The fashion accessory of claim 2 comprising a shoe.

11. The fashion accessory of claim 1 further comprising:
an antenna electrically coupled to the electronic circuit, the antenna configured to receive an ac power signal transmitted by a wireless power transfer transmitter circuit located outside the fashion accessory.

12. The fashion accessory of claim 11 wherein the electronic circuit and the antenna are enclosed inside a surface defining an interior of the fashion accessory.

13. A fashion accessory comprising:
an electronic circuit embedded inside an accoutrement attached to an exterior of the fashion accessory, the electronic circuit configured to receive a wireless signal from an electronic device operatively coupled to the electronic circuit, the wireless signal indicating an incoming message to the electronic circuit; and
an indicator on an exterior of the accoutrement and electrically responsive to the electronic circuit receiving the wireless signal.

14. The fashion accessory of claim 13 wherein the indicator further comprises an indicia of a brand associated with the fashion accessory.

15. The fashion accessory of claim 14 wherein the indicator comprises authentication information to verify authenticity of the fashion accessory.

16. fashion accessory of claim 15 wherein the electronic circuit is configured to illuminate the indicia of the brand responsive to determining that the fashion accessory is authentic.
